(19) United States
(12) Patent Application Publication
(10) Pub. No.: US 2016/0016301 A1
(43) Pub. Date: Jan. 21, 2016

(54) Technology to fasten or attach a squeegee to a duct knife or duct knife sheath

(71) Applicant: Miles Heitzeberg, Tequesta, FL (US)

(72) Inventor: Miles Heitzeberg, Tequesta, FL (US)

(21) Appl. No.: 14/457,027

(22) Filed: Aug. 11, 2014

Related U.S. Application Data
(60) Provisional application No. 62/024,956, filed on Jul. 15, 2014.

(51) Int. Cl. B25G 1/08; B25G 3/00; F16B 1/00

(52) U.S. Cl. CPC B25G 1/08; F16B 1/00; B25G 3/00; F16B 2001/0035

(57) ABSTRACT

Ability to fasten a squeegee to a duct knife or a duct knife sheath. This will solve the problem of where to put the squeegee when not using it. Squeegee secured to duct knife sheath allowing convenient access and reducing the chance of misplacing the squeegee.

### BACKGROUND OF THE INVENTION

The primary field for this invention is heating, ventilation and air conditioning or HVAC. The two tools involved in this invention are multipurpose tools with countless applications. Duct knives have a two sided blade(one serrated side), they're used to cut insulation and ductboard. A squeegee is a cheap plastic tool used to smooth and seal tape using friction and pressure.

The technology solves the problem of having no place to put a squeegee down when not using it; and providing ease of access when the need occurs. Previously, techs would rely on bulky tool belts or pants pockets to store the squeegee.

### BRIEF SUMMARY OF THE INVENTION

The two tools involved in this invention are multipurpose tools with countless applications. Duct knives have a two sided blade(one serrated side), they're used to cut insulation and ductboard. A squeegee is a cheap plastic tool used to smooth and seal tape using friction and pressure.

Current duct knives on the market include a sheath or holster that techs can thread their belts through to have access to the knife right on their hip. Currently there is not a designated place for a squeegee. The invention is the ability to fasten the squeegee to the sheath, or directly to the knife in future applications. To do this the squeegee and/or sheath/knife are altered to allow the squeegee to be attached to the sheathed knife or sheath.

The first application of this technology will include an altered squeegee and altered sheath. The squeegee fitted with a metal insert and the sheath fitted with a magnet.

### BRIEF DESCRIPTION OF THE SEVERAL VIEWS OF THE DRAWINGS

FIG. 1 is a view of a duct knife, a sheath and a squeegee. The items included in the invention before the technology is applied.

FIG. 2 is a view of a sheath with a magnet placed on it.

FIG. 3 is a view of a magnet sewn onto a sheath

FIG. 4 is a view of a squeegee with added metal insert.

FIG. 5 is a view of the technology in use; the squeegee is attached to the technicians sheath providing ease of access.

### DETAILED DESCRIPTION OF THE INVENTION

In the various embodiments of the invention there is generally a metal insert attached to a squeegee, the metal allows the normally all plastic squeegee to be attached to a magnet. The magnet will attach to the host tool, a duct knife duct knife sheath or other related tools.

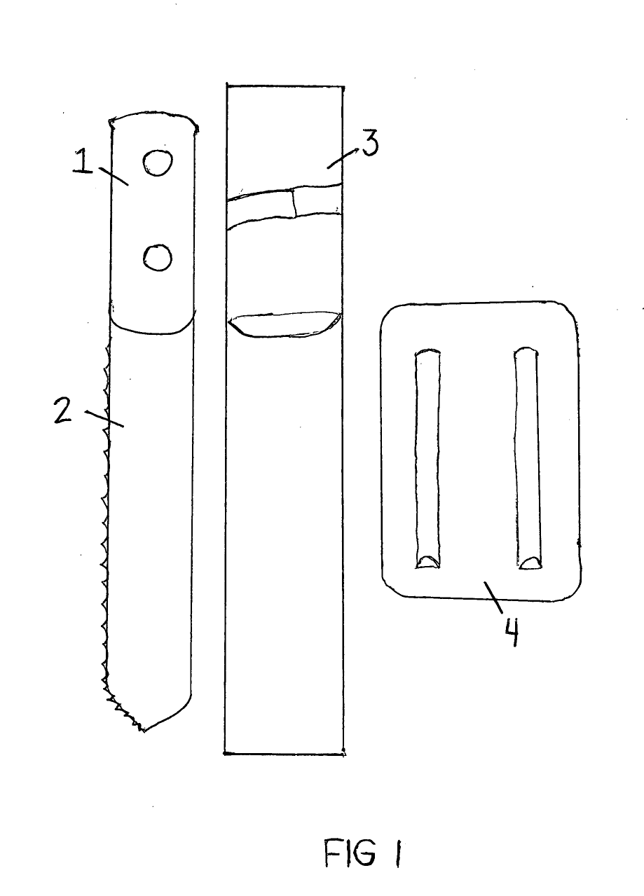

Referring to the drawings FIG. 1 shows the three basic components involved in the invention before the technology is applied. The standard duct knife handle 1 and blade 2, the knife's sheath 3 and a basic plastic squeegee 4.

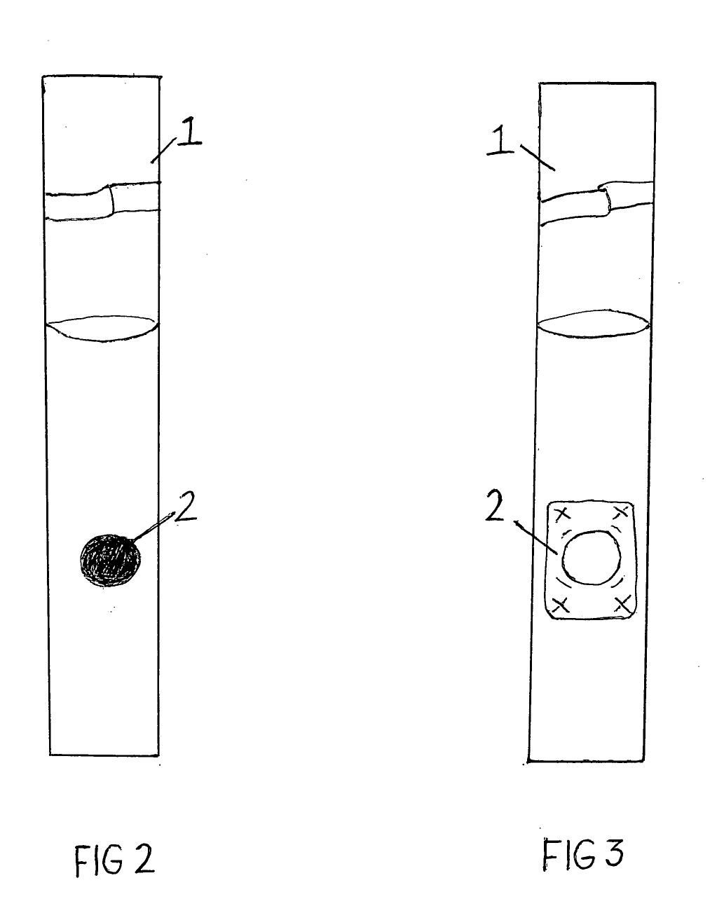

FIG. 2 shows a magnet 2 place on a sheath 1.

FIG. 3 shows the magnet is covered with cloth 2 which is sewn to the sheath 1.

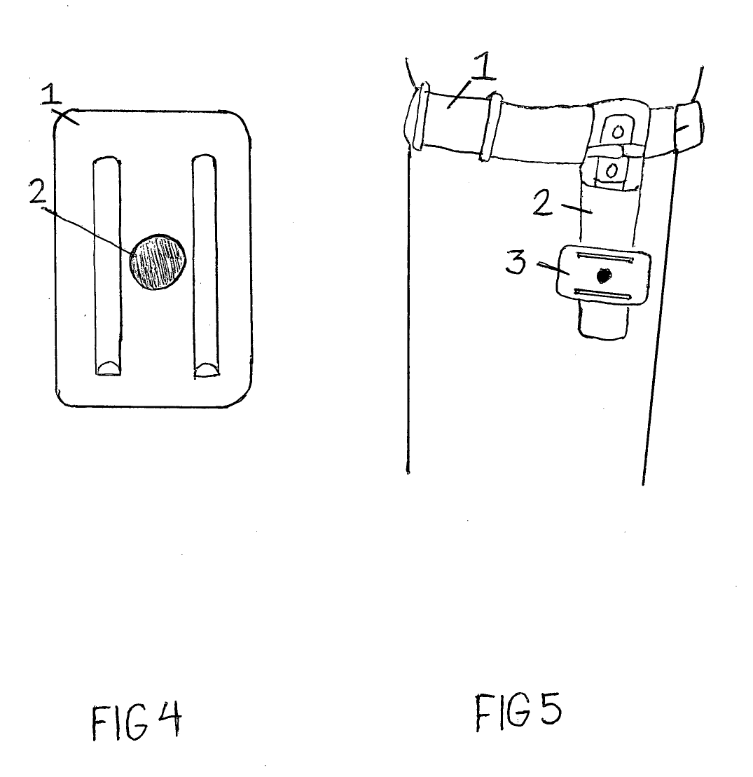

FIG. 4 shows a plastic squeegee 1 with attached metal insert 2.

FIG. 5 shows a practical application of the invention. The technician's belt 1 Threads through the sheath 2 allowing for access to the knife and squeegee 3. The magnet on the sheath 2 and the metal in the squeegee 3 allow the two tools to be paired for convenience.

1. What I claim as my invention is the ability to fasten or attach a squeegee to a duct knife or duct knife sheath.
